(19) United States
(12) Patent Application Publication
(10) Pub. No.: US 2010/0299911 A1
(43) Pub. Date: Dec. 2, 2010

(54) METHODS FOR MANUFACTURING AN ENDOPROSTHESIS

(75) Inventors: Marc G. Gianotti, Wiesendangen (CH); Kelly A. Pike, Half Moon Bay, CA (US)

Correspondence Address: WORKMAN NYDEGGER, 1000 EAGLE GATE TOWER,, 60 EAST SOUTH TEMPLE, SALT LAKE CITY, UT, 84111, US

(73) Assignee: ABBOTT CARDIOVASCULAR SYSTEMS, INC., Santa Clara, CA (US)

(21) Appl. No.: 12/778,589

(22) Filed: May 12, 2010

Related U.S. Application Data
(60) Provisional application No. 61/177,936, filed on May 13, 2009.

(51) Int. Cl. B23P 17/04

(52) U.S. Cl. 29/592

(57) ABSTRACT

Method for manufacturing an endoprosthesis are described. The method may include selecting an indication range based on a range of inner diameters of a body lumen. A nominal diameter of the endoprosthesis may be selected. A range of chronic outward force, a range of radial force, a range of safety factors, or combinations thereof may be selected. A design characteristic may be determined based on the indication range, the nominal diameter, and at least one of the range of chronic outward force, the range of radial force, and the range of safety factors. The endoprosthesis may be manufactured based on the determined design characteristic.

### CROSS-REFERENCE TO RELATED APPLICATIONS

This application claims the benefit of and priority to U.S. Provisional Patent Application Ser. No. 61/177,936, filed May 13, 2009, and entitled “LOW RADIAL FORCE SELF-EXPANDING STENTS,” the disclosure of which is hereby incorporated by reference in its entirety.

### BACKGROUND OF THE INVENTION

I. The Field of the Invention

The present invention generally relates to the field of medical devices. More specifically, the present invention relates to methods, systems, and devices for manufacturing an endoprosthesis.

II. Related Technology

Stents are often used to reinforce the wall of a vessel that has decreased in diameter for a variety of reasons. For example, a stent may provide additional structural support that may help maintain a vessel opened and functioning properly. Two types of stents that may be used include a self-expanding stent and a balloon-expandable stent.

Self-expanding stents may be constructed to have a structure that utilizes superelastic properties of the material of which they are constructed. A self-expanding stent is usually compressed before deployment. Once deployed, the self-expanding stent expands radially toward its nominal size. As the self-expanding stent expands, it exerts an outward radial force on the vessel wall to help maintain the vessel wall open. Furthermore, a self-expanding stent may be post-dilated, such that the stent expands beyond its nominal size to disrupt a lesion or otherwise prepare the vessel for the stent's deployed life.

Balloon-expandable stents may be constructed to have a structure that may be radially plastically deformed by a balloon. The balloon may be used to expand the stent beyond its nominal size to prepare the vessel for the stent's deployed life. Once deployed, the balloon-expandable stent contracts radially toward its nominal size. After the balloon-expandable stent contracts to and/or toward its nominal size, it exerts an outward radial force on the vessel wall to help maintain the vessel wall open.

The amount of force applied by a stent may be related to the difference between the size of the vessel and the size of the stent in its deployed state. Often, high radial force stents are used to help ensure that sufficient force is exerted. As a result, if the difference between the diameter of the vessel and the stent is large, the stent may be highly compressed. For example, a one millimeter overcompression of a self-expanding stent may result in a 100% increase in the radial force exerted by the self-expanding stent.

While the force applied by a stent, the stent may help maintain a vessel open, if the force is too large that force may cause the stent to at least irritate the vessel wall if not migrate through it in the process damaging many layers of differentiated tissue which compose the vessel wall. The irritation and/or migration of the stent through the vessel wall may result in restensosis, including the formation of scar tissue and/or the promotion of local smooth muscle cell proliferation that may result in a decrease in the diameter of the vessel.

Therefore, a need may exist for a method of manufacturing an endoprosthesis that overcomes at least one of these challenges.

### BRIEF SUMMARY

The purpose and advantages of the present invention will be set forth in and are apparent from the description that follows, as well as will be learned by practice of the invention. Additional advantages of the invention will be realized and attained by the methods and devices particularly pointed out in the written description and claims hereof, as well as from the appended drawings.

An embodiment of a method for manufacturing an endoprosthesis is described. The method includes selecting an indication range based on a range of inner diameters of a body lumen. A nominal diameter of the endoprosthesis is selected. A range of chronic outward force is selected. A design characteristic is determined based on the indication range, the nominal diameter, and the range of chronic outward force.

In some embodiments, the method may include selecting a nominal chronic outward force. The nominal chronic outward force may be at least sufficient to maintain vessel patency. The range of chronic outward force, in further embodiments, may be between about 0 N to about 10 N, between about 1 N to about 8 N, or between about 3 N to about 6 N.

The indication range, in some embodiments, may be between about 1 mm to about 5 mm of inner diameters of the vessel. In further embodiments, the indication range is based on a length of a treatment site. The nominal diameter, in still further embodiments, may be between about 4 mm and about 12 mm.

In some embodiments, the design characteristic is at least one of material type, material processing, web pattern, wall coverage, vessel compliance, and fatigue life. The design characteristic, in further embodiments, may be the web pattern and the web pattern may include a plurality of struts and a plurality of crowns connecting the plurality of struts. In still further embodiments, an aspect of the plurality of struts may be determined based on the indication range and the range of chronic outward force.

A further embodiment of a method for manufacturing an endoprosthesis is described. The method includes selecting an indication range based on a range of inner diameters of a body lumen. A nominal diameter of the endoprosthesis is selected. A range of safety factors is selected. A design characteristic is determined based on the indication range, the nominal diameter, and the range of safety factors.

In some embodiments, the indication range is between about 1 mm to about 5 mm of inner diameters of the vessel and the range of safety factors extends from at least about 1. The safety factors, in further embodiments, may be based on an endoprosthesis design that does not fracture for about four million pulse cycles at about three percent vessel dilation.

The nominal diameter of the endoprosthesis, in some embodiments, may be about 6 mm and the indication range may extend from about 2 mm of inner diameters of the vessel and the range of safety factors may extend from at least about 1 to about 10. In further embodiments, the nominal diameter of the endoprosthesis may be about 8 mm and the indication range may extend from about 4.5 mm of inner diameters of the vessel and the range of safety factors may extend from at least about 4 to about 14. The nominal diameter of the endoprosthesis, in still further embodiments, may be about 6 mm and the indication range may extend from about 2.5 mm of inner diameters of the vessel and the range of safety factors may extend from at least about 9 to about 19.

In some embodiments, the design characteristic may be at least one of material type, material processing, web pattern, wall coverage, vessel compliance, and fatigue life. The design characteristic, in further embodiments, may be the web pattern and the web pattern may include a plurality of struts and a plurality of crowns connecting the plurality of struts. In still further embodiments, a length of the plurality of struts may be determined based on the indication range and the range of safety factors.

A still further embodiment of method for manufacturing a self-expanding stent is described. The method includes selecting an indication range based on a range of inner vessel diameters, the indication range being between about 3.0 mm to about 5.5 mm. A range of chronic outward force extending between about 3 N to about 6 N is selected. A design characteristic is determined based on a nominal diameter of about 6.0 mm, the indication range, and the range of chronic outward force. The method includes manufacturing the self-expanding stent based on the determined design characteristic.

In some embodiments, a nominal chronic outward force may be about 15 N. The range of chronic outward force, in further embodiments, extends from about 9 N to about 18 N.

A yet further embodiment of a method for manufacturing an endoprosthesis is described. The method includes selecting an indication range based on a range of inner diameters of a body lumen. A nominal diameter of the endoprosthesis is selected. A range of radial force is selected. A design characteristic is determined based on the indication range, the nominal diameter, and the range of radial force.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a graph of the radial forces experienced over time by an endoprosthesis;

FIG. 2 illustrates an embodiment of a method for manufacturing an endoprosthesis;

FIG. 3 illustrates another embodiment of a method for manufacturing an endoprosthesis;

FIG. 4 illustrates a graph of a chronic outward force over diameter curve of an embodiment of an endoprosthesis;

FIG. 5 illustrates a graph of a chronic outward force over diameter curve of an embodiment of an endoprosthesis having a substantially constant nominal chronic outward force over a selected indication range;

FIG. 6 illustrates a graph of a chronic outward force over diameter curve of the embodiment of an endoprosthesis shown in FIG. 4 having a range of chronic outward force that is substantially the same as an upper range of chronic outward force;

FIG. 7 illustrates a graph of a chronic outward force over diameter curve of an embodiment of an endoprosthesis having a first and second nominal chronic outward force over a first and second indication range;

FIG. 8 illustrates a graph of a radial force over diameter curve of an embodiment of an endoprosthesis having a range of radial force that includes an upper and lower range of chronic outward force that have different values;

FIG. 9 illustrates a graph of a radial force over diameter curve of an embodiment of an endoprosthesis having a first, second, and third nominal radial forces over a first, second, and third indication range, respectively;

FIG. 10 is an illustration of an embodiment of a stent;

FIG. 11 is an illustration of a web pattern of the stent of FIG. 10 in an uncompressed state;

FIG. 12 is an illustration of the web pattern of FIG. 11 in a compressed state;

FIGS. 13-15 illustrate graphs of various safety factor over diameter curves of embodiments of endoprostheses.

### DETAILED DESCRIPTION

In accordance with the present disclosure, methods for manufacturing an endoprosthesis are described. Endoprostheses can include, but are not limited to, stents, filters, grafts, valves, occlusive devices, trocars, aneurysm treatment devices, or the like. The endoprosthesis of the present disclosure can be configured for a variety of intralumenal applications, including vascular, coronary, biliary, esophageal, urological, gastrointestinal or the like. Although the examples provided herein discuss the use of stents, other endoprostheses, such as those described above, are also considered within the scope of the present disclosure.

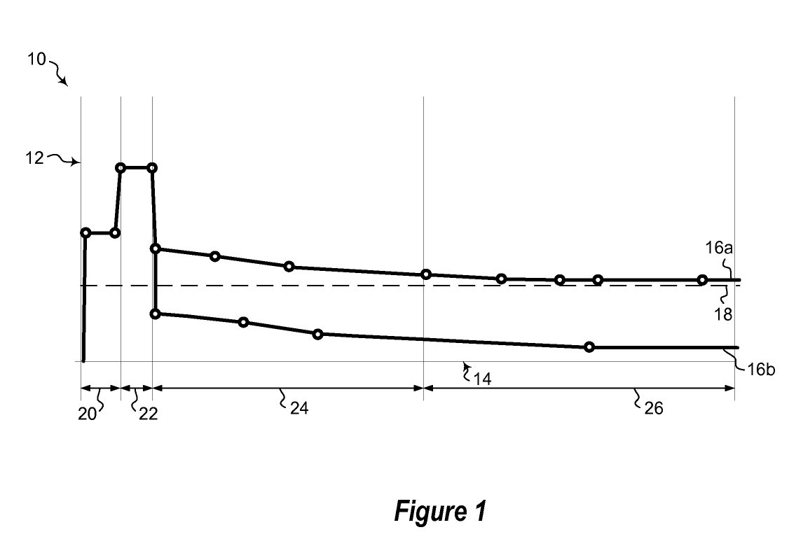

Referring now to the drawings, FIG. 1 illustrates a graph 10 of the radial forces 12 experienced over time 14 by an endoprosthesis. The graph 10 illustrates two lines 16a, 16b. The first line 16a represents an exemplary endoprosthesis that may have been designed such that the radial forces approach a lower injury limit 18 over time. The second line 16b represents a second exemplary endoprosthesis that may have been designed such that the radial forces are below the lower injury limit 18 after the endoprosthesis is placed.

The endoprostheses may experience radial forces in phases. The phases may include a deployment 20, post dilation 22, intermediate 24, and chronic phase 26. The deployment phase 20 may include the radial forces experienced by a self-expanding endoprosthesis while compressed within a deployment device. For balloon-expandable endoprostheses, the deployment phase 20 may include the radial forces, whether compressive or expansive, experienced by an endoprosthesis within a deployment device.

The post dilation phase 22 may include the radial forces experienced by an endoprosthesis while being expanded by a balloon or other device. The post dilation phase 22 may apply to a self-expanding stent, a balloon-expandable stent, or other stents or endoprostheses. For instance, as shown by the graph 10, the radial forces experienced by an endoprosthesis during the post dilation phase 22 may be larger than the radial forces experienced in any other phase. Radial forces experienced by an endoprosthesis in the post dilation phase 22 may be sufficient to cause the endoprosthesis to disrupt an outer surface of a lesion.

The radial forces experienced by the first endoprosthesis, as indicated by line 16a, immediately after the post dilation phase 22 return generally to the level of radial forces experienced during the deployment phase 20. The radial forces experienced by the second endoprosthesis, as indicated by line 16b, immediately after the post dilation phase 22 decrease below the lower injury limit 18.

The intermediate phase 24 may include the radial forces experienced by an endoprosthesis after being expanded by a balloon or other device as the radial forces reduce toward the chronic phase 26. The intermediate phase 24 may extend between a few minutes and a few hours after the deployment phase 20 and/or the post dilation phase 22. The chronic phase 26 may include the radial forces experienced by the endoprosthesis following the intermediate phase 24.

Designing an endoprosthesis such that the radial forces experienced during the intermediate phase 24 and/or the chronic phase 26 are below the lower injury limit 18 may reduce and/or eliminate mechanical irritation, vessel migration, restenosis, other vessel maladies, or combinations thereof.

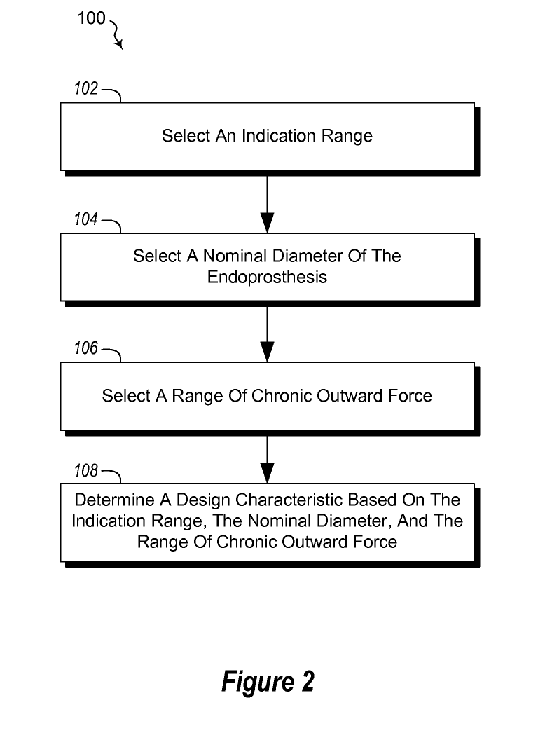

FIG. 2 illustrates an embodiment of a method 100 for manufacturing an endoprosthesis. The method 100 may include the act 102 of selecting an indication range. An indication range, as will be discussed in more detail below, may include a range of diameters of a vessel or body lumen for which the endoprosthesis may be used. For example, an indication range may be between about 0.5 mm to about 5.5 mm, between about 1.5 mm to about 4 mm, between about 1 mm to about 3.5 mm, about 3.5 mm, about 1 mm, or other indication ranges. In some embodiments, the indication range may be selected based on a length of a treatment site.

A nominal diameter of the endoprosthesis may be selected, as indicated by act 104. The nominal diameter may be the diameter of the endoprosthesis after deployment but without any compressive forces from a vessel or body lumen. For example, for a self-expanding stent the nominal diameter may be the diameter to which the self-expanding stent would return after being deployed without further resistance. In another example, for a balloon-expandable stent the nominal diameter may be the diameter to which the balloon-expandable stent would return after being deployed by a balloon outside the body. The nominal diameter is typically larger than the diameter of a vessel or body lumen into which the endoprostheses may be deployed. The nominal diameter may be between about 4 mm and about 12 mm, between about 5 mm and about 8 mm, or other diameters.

A range of chronic outward force may be selected, as indicated by act 106. The range of chronic outward force, as will be discussed more below, may be the forces between a lower limit and an upper limit of chronic outward force. The chronic outward force may include the radial force an endoprosthesis exerts on an ongoing basis. The chronic outward force may be tested using equipment used to simulate the compressive forces experienced by an endoprosthesis, such as stent, during at least the intermediate and chronic phases of an endoprosthesis deployment. Thus, an endoprosthesis may be designed to provide the selected range of chronic outward force, and may later be tested to determine whether the endoprosthesis satisfies this design characteristic.

A design characteristic may be determined based on the indication range, the nominal diameter, and the range of chronic outward force, as indicated by act 108. Design characteristics may include, but are not limited to, the following: the material, such as the type of material, the constituents of the material, other material characteristics, such as tensile strength, hardness, fracture toughness, creep, fatigue strength, elasticity, plasticity, solubility, other characteristics, or combinations thereof; material processing, such as heat treatments, cold working, laser or other cutting, chemical or other etching, coatings, or other material processes; joining processes, such as welding or other joining processes; web pattern, such as strut shape, dimensioning, spacing or other strut characteristics, crown shape, dimensioning, or other crown characteristics, wall coverage (i.e. endoprosthesis outer surface to body lumen outer surface ratio), or other web pattern characteristics; fatigue life, other characteristics, or combinations thereof. Design characteristics may be interrelated. For example, if the material selected is purely elastic, the web pattern may be an important design characteristic, while if the material is generally inelastic, the web pattern may be of less importance.

After the design characteristic is determined, according to act 108, the endoprosthesis may be manufactured according to the design characteristic. For example, for a web pattern design characteristic determined based on the indication range, nominal diameter, and range of chronic outward force, an endoprosthesis may be manufactured with the determined web pattern.

In one example, based on a nominal diameter of 6 mm over an indication range of about 0.5 mm to about 5.5 mm of a body lumen or vessel and a range of chronic outward force of about 0 N to about 10 N, a design characteristic may be determined. For instance, a web pattern may be selected for the 6 mm nominal diameter endoprosthesis to provide the about ON to about 10 N range of chronic outward force over the about 0.5 mm to about 5.5 mm indication range. In another example, a material may be selected or designed for the nominal diameter, indication range, and range of chronic outward force. Other exemplary ranges of chronic outward force may be between about 1 N to about 8 N, between about 3 N to about 6 N, about 6 N, or about 3 N. In other examples, larger and/or smaller indication ranges, ranges of chronic outward force, or nominal diameters may be used.

Although this example describes the selection of a single design characteristic, the selected indication range, range of chronic outward force, and nominal diameter may be used to determine a plurality of design characteristics. For example, the web pattern and the material may be determined based on the selected indication range, range of chronic outward force, and nominal diameter.

Furthermore, other aspects of the design may be selected and used to determine at least one design characteristic. For instance, a nominal chronic outward force may be selected. The nominal chronic outward force may be a chronic outward force selected below a lower injury limit and/or may vary depending on the expected compressive forces in a body lumen or vessel. For instance, an exemplary nominal chronic outward force for an iliac may be about 15 N. The minimum chronic outward force for which a stent in a blood vessel may be designed may be the force provided by the blood pressure in that vessel.

Use of the method 100 for manufacturing an endoprosthesis may reduce the number of individual sizes of endoprostheses that are used as part of a product matrix. In particular, conventional product matrices generally provide endoprostheses to cover a broad range of body lumen diameters. In such matrices, the endoprostheses may provide a relatively high nominal chronic outward force with a relatively high range of chronic outward force over a relatively narrow indication range. Accordingly, endoprostheses in such matrices are often provided with relatively small indication ranges.

Thus manufacturing an endoprosthesis according to this, or other methods described herein may provide endoprostheses having relatively flat chronic outward force over diameter curves that may allow for a matrix to include fewer products while still covering the same range of body lumen diameters. A relatively smaller matrix may reduce manufacturing costs, as fewer sizes of endoprostheses may need to be manufactured, which may reduce tooling costs and/or inventory costs. Similarly, a relatively smaller matrix may also reduce costs associated with medical procedures by, for example, reducing inventory costs and/or reducing complications caused by improper sizing, such as body lumen irritation, migration, restenosis, other maladies, or combinations thereof. Furthermore, by broadening the indication range of an endoprosthesis, the procedural time for placing an endoprosthesis may be reduced by reducing the amount of time to measure a body lumen.

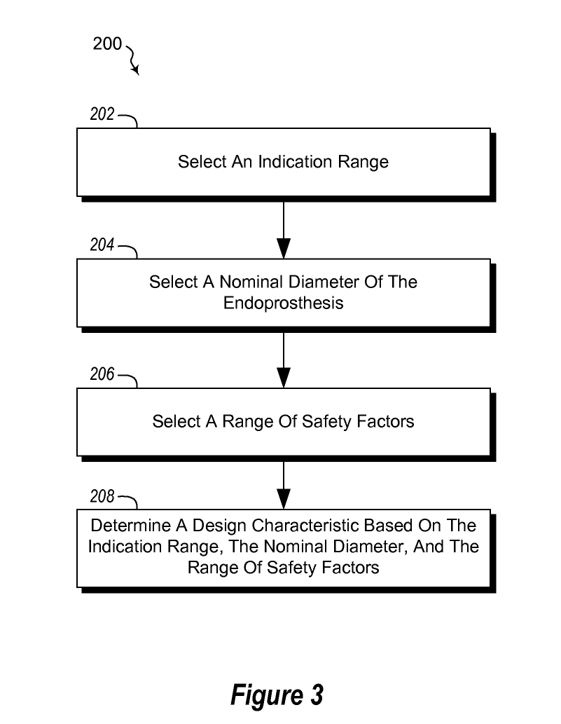

FIG. 3 illustrates another embodiment of a method 200 for manufacturing an endoprosthesis. The method 200 of this other embodiment may be similar to the method 100 previously described above and shown in FIG. 2 in most respects, wherein certain features will not be described in relation to this embodiment wherein those elements or acts may be similar to the elements or acts as described above and are hereby incorporated into this alternative embodiment described below. Like elements or acts may be given like reference numerals.

The method 200 may include the act 202 of selecting an indication range and the act 204 of selecting a nominal diameter of the endoprosthesis. The method 200 may include the act 206 of selecting a range of safety factors.

A safety factor may include the ratio of a maximum force (or stress) which an endoprosthesis can withstand without fracture to the force (or stress) that the endoprosthesis was designed to withstand during normal use. The force (or stress) that the endoprosthesis was designed to withstand during normal operation may include the radial forces (or stresses) experienced by the endoprosthesis during at least one of the deployment, post dilation, intermediate, and chronic phases. The safety factor may consider the fatigue life of the endoprosthesis over its normal design life. For example, the safety factor may consider the maximum amount of force (or stress) that the endoprosthesis can withstand over a desired amount of cycles. In another example, the safety factor may include the ratio of a maximum force (or stress) which an endoprosthesis can withstand without fracture to the force (or stress) that the endoprosthesis was designed to withstand during normal operation for about four million pulse cycles at about three percent vessel dilation.

The range of safety factors, as will be discussed further below, may be the safety factors between a lower limit and an upper limit of the safety factors. The range of safety factors may extend from about 1, from about 1 to about 10, from about 1 to about 4, from about 4 to about 14, from about 8 to about 14, from about 9 to about 19, from about 12 to about 19, to about 20, or from and/or to other safety factors. Thus, an endoprosthesis may be designed to provide the selected range of safety factors, and may later be tested to determine whether the endoprosthesis satisfies this design characteristic.

A design characteristic may be determined based on the indication range, the nominal diameter, and the range of safety factors, as indicated by act 208. After the design characteristic is determined, according to act 208, the endoprosthesis may be manufactured according to the design characteristic. For example, for a material design characteristic determined based on the indication range, nominal diameter, and range of safety factors, an endoprosthesis may be manufactured with the determined material.

In one example, based on a nominal diameter of 6 mm over an indication range of about 0.5 mm to about 5.5 mm of a body lumen or vessel and a range of safety factors of more than about 1, a design characteristic may be determined. For instance, a web pattern, other design characteristic, or combination of design characteristics may be selected for the 6 mm nominal diameter endoprosthesis to provide a safety factor of more than about 1 over the about 0.5 mm to about 5.5 mm indication range. Depending on the location of the implantation, additional anatomical forces may be present such that the design may be modified to not exceed a SF of 1 under the worst likely case. In other examples, larger and/or smaller indication ranges, ranges of chronic outward force, or nominal diameters may be used.

Although this example describes the selection of a single design characteristic, the selected indication range, range of chronic outward force, and nominal diameter may be used to determine a plurality of design characteristics. For example, the web pattern and the material may be determined based on the selected indication range, range of chronic outward force, and nominal diameter. Furthermore, other aspects of the design may be selected and used to determine at least one design characteristic.

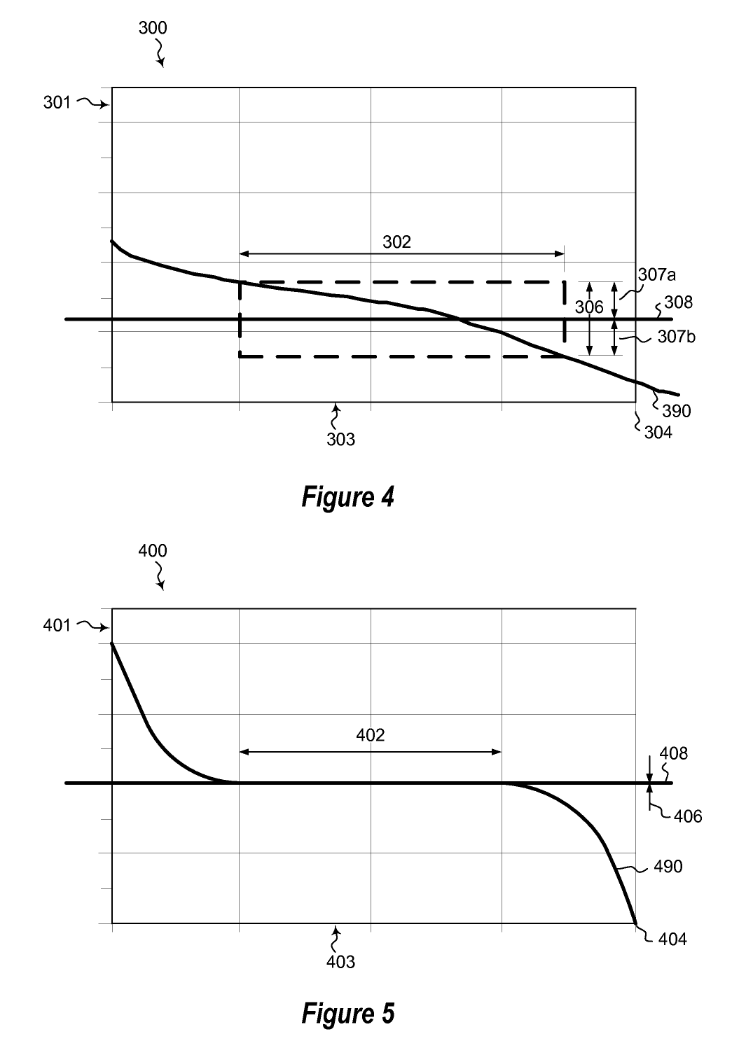

FIG. 4 illustrates a graph 300 of a curve 390 of a range of chronic outward forces 301 over a range of body lumen or vessel diameters 303 of an embodiment of an endoprosthesis. The range of forces 301 may extend from the about 0 N to about 45 N and the range of diameters 303 may extend from about 2.0 mm to about 6.0 mm. The present embodiment of an endoprosthesis may have a nominal diameter 304 of about 6 mm. In other embodiments, the endoprosthesis may have another nominal diameter 304.

The chronic outward force over diameter curve 390 may be specific to the nominal diameter 304, the design characteristics described herein, other design characteristics, or combinations thereof. The chronic outward force over diameter curve 390, as described above, may be determined after an endoprosthesis is designed. For example, the methods of 100, 200 for manufacturing an endoprosthesis described above may produce an endoprosthesis that may be tested to generate such a curve 390.

In the present embodiment, the chronic outward force over diameter curve 390 may be generated by an endoprosthesis with at least one design characteristic determined based on an indication range 302, a range of chronic outward force 306, and the nominal chronic outward force 308. The selected indication range 302 may extend from about 3.0 mm to about 5.5 mm or, in other words, the selected indication range 302 may be about 2.5 mm. The selected nominal chronic outward force 308 may be about 15 N.

The selected range of chronic outward force 306 may extend from a lower limit of about 9 N to an upper limit of about 18 N, or, in other words, the selected range of chronic outward force 306 may be about 9 N.

The selected range of chronic outward force 306 may include an upper range 307a and/or a lower range 307b. The upper range 307a may be about 3 N and the lower range 307b may be about 6 N. In other embodiments, the upper range 307a and the lower range 307b may be the same. In further embodiments, the range of chronic outward force 306 may only include the upper range 307a or the lower range 307b.

Although the method 100 described above includes the act 106 of selecting a range of chronic outward force, it will be appreciated that components of the range of chronic outward force, such as the lower limit, the upper limit, an upper range, a lower range, other components of the range of chronic outward force, or combinations thereof may be selected.

The chronic outward force over diameter curve 390 may have a slope. As shown in the graph 300, the slope of the chronic outward force over diameter curve 390 is not constant and is relatively small. Other chronic outward force over diameter curves may satisfy the indication range, nominal diameter, and the range of chronic outward force requirements shown in FIG. 4. For example, an endoprosthesis designed to satisfy these requirements may have a chronic outward force over diameter curve with a constant slope of −4.5 N/mm that extends from about 19 N at about 3.0 mm to about 9 N at about 5.5 mm, but which may vary outside of the selected indication range 302 and selected range of chronic outward force 306.

Any other chronic outward force over diameter curve 390 for an endoprosthesis that falls within the indication range 302 and the range of chronic outward force 306 may satisfy the act 106 of determining at least one design characteristic. Although, other design criteria than the indication range 302 and the range of chronic outward force 306 may be considered, such as the nominal diameter 304, nominal chronic outward force 308, other design criteria or characteristics, or combinations thereof.

It will be appreciated that the smaller the range of chronic outward force over a larger indication range may reduce the need for multiple endoprostheses to cover multiple smaller indication ranges.

FIG. 5 illustrates a graph 400 of a curve 490 of a range of chronic outward forces 401 over a range of body lumen or vessel diameters 403 of an embodiment of an endoprosthesis having a substantially constant slope over a selected indication range 402. The graph 400 of this other embodiment may be similar to the graph 300 previously described above and shown in FIG. 4 in most respects, wherein certain aspects will not be described in relation to this embodiment wherein those aspects may be similar to the aspects as described above and are hereby incorporated into this alternative embodiment described below. Like elements may be given like reference numerals.

The range of forces 401 may extend from the about 0 N to about 45 N and the range of diameters 403 may extend from about 2.0 mm to about 6.0 mm. The present embodiment of an endoprosthesis may have a nominal diameter 404 of about 6 mm. In other embodiments, the endoprosthesis may have another nominal diameter 404.

In the present embodiment, the chronic outward force over diameter curve 490 may be generated by an endoprosthesis with at least one design characteristic determined based on an indication range 402, a range of chronic outward force 406, and the nominal chronic outward force 408. The selected indication range 402 may extend from about 3.0 mm to about 5.0 mm or, in other words, the selected indication range 402 may be about 2.0 mm. The selected nominal chronic outward force 408 may be about 20 N.

The selected range of chronic outward force 406 may be about 0 N. In other words, the selected range of chronic outward force 406 may not be a range at all but rather may be approximately the same as the nominal chronic outward force 408.

The chronic outward force over diameter curve 490 may have a slope. As shown in the graph 400, the slope of the chronic outward force over diameter curve 490 is approximately zero. Other chronic outward force over diameter curves may satisfy the indication range, nominal diameter, and the range of chronic outward force requirements shown in FIG. 4. For example, an endoprosthesis designed to satisfy these requirements may have a chronic outward force over diameter curve with a zero slope that extends from about 20 N at 3.0 mm to about 20 N at 5.0 mm, but which may vary outside of the selected indication range 402 and selected range of chronic outward force 406.

Any other chronic outward force over diameter curve 490 for an endoprosthesis that falls within the indication range 402 and the range of chronic outward force 406 may satisfy the act 106 of determining at least one design characteristic. Although, other design criteria than the indication range 402 and the range of chronic outward force 406 may be considered, such as the nominal diameter 404, nominal chronic outward force 408, other design criteria or characteristics, or combinations thereof

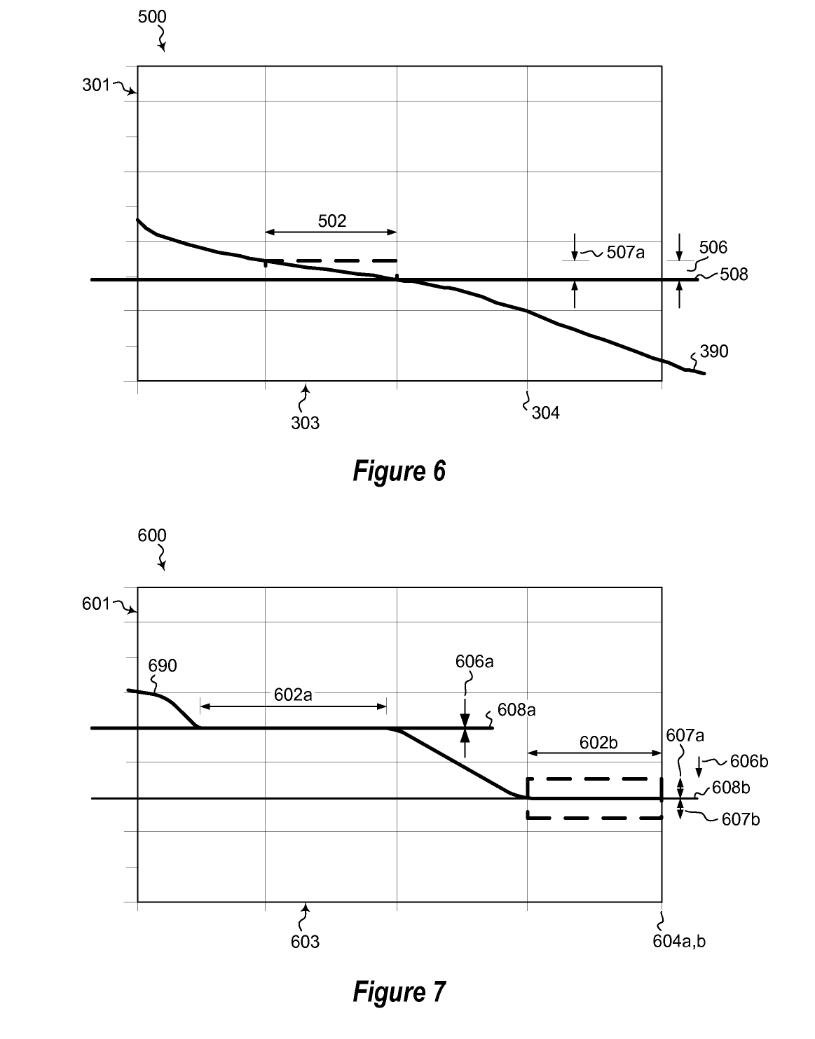

FIG. 6 illustrates a graph 500 of the curve 390 of the range of chronic outward forces 301 over the range of diameters 303 of the embodiment of the endoprosthesis shown in FIG. 4 having a range of chronic outward force 506 that is substantially the same as an upper range 507a of chronic outward force. The graph 500 of this other embodiment may be similar to the graphs 300, 400 previously described above and shown in FIGS. 4-5 in most respects, wherein certain aspects will not be described in relation to this embodiment wherein those aspects may be similar to the aspects as described above and are hereby incorporated into this alternative embodiment described below. Like elements may be given like reference numerals.

In the present embodiment, the chronic outward force over diameter curve 390 may be generated by an endoprosthesis with at least one design characteristic determined based on an indication range 502, a range of chronic outward force 506, and the nominal chronic outward force 508. The selected indication range 502 may extend from about 3.0 mm to about 4.0 mm or, in other words, the selected indication range 502 may be about 1.0 mm. The selected nominal chronic outward force 508 may be about 15 N.

The selected range of chronic outward force 506 may extend from a lower limit of about 15 N to an upper limit of about 18 N, or, in other words, the selected range of chronic outward force 506 may be about 3 N.

The selected range of chronic outward force 506 may include an upper range 507a and/or a lower range. The upper range 507a may be about 3 N and the lower range may be about ON. In other words, the selected range of chronic outward force 506 may not include a lower range.

The chronic outward force over diameter curve 390 may have a slope. As shown in the graph 300, the slope of the chronic outward force over diameter curve 390 is not constant and is relatively small. Other chronic outward force over diameter curves may satisfy the indication range, nominal diameter, and the range of chronic outward force requirements shown in FIG. 6. For example, an endoprosthesis designed to satisfy these requirements may have a chronic outward force over diameter curve with a constant slope of −4.0 N/mm that extends from 19 N at 3.0 mm to 15 N at 4.0 mm, but which may vary outside of the selected indication range 502 and selected range of chronic outward force 506.

Any other chronic outward force over diameter curve 390 for an endoprosthesis that falls within the indication range 502 and the range of chronic outward force 506 may satisfy the act 106 of determining at least one design characteristic. Although, other design criteria than the indication range 502 and the range of chronic outward force 506 may be considered, such as the nominal diameter 304, nominal chronic outward force 508, other design criteria or characteristics, or combinations thereof.

FIG. 7 illustrates a graph 600 of a curve 690 of a range of chronic outward forces 601 over a range of body lumen or vessel diameters 603 of an embodiment of an endoprosthesis having a first and second nominal chronic outward force 608a, 608b over a first and second indication range 602a, 602b. The graph 600 of this other embodiment may be similar to the graphs 300, 400, 500 previously described above and shown in FIGS. 4-6 in most respects, wherein certain aspects will not be described in relation to this embodiment wherein those aspects may be similar to the aspects as described above and are hereby incorporated into this alternative embodiment described below. Like elements may be given like reference numerals.

The range of forces 601 and the range of diameters 603 may be the same as the ranges of forces 301, 401 and ranges of diameters 303, 403 described above. The present embodiment of an endoprosthesis may have a nominal diameter 604a, 604b of about 6 mm. In other embodiments, the endoprosthesis may have another or differing nominal diameters 604a, 604b.

In the present embodiment, the chronic outward force over diameter curve 690 may be generated by an endoprosthesis with at least one design characteristic determined based on the first indication range 602a, the first range of chronic outward force 606a, the first nominal chronic outward force 608a, the second indication range 602b, the second range of chronic outward force 606b, and the second nominal chronic outward force 608b. The first selected indication range 602a may extend from about 2.5 mm to about 4.0 mm or, in other words, the first selected indication range 602a may be about 1.5 mm. The first selected nominal chronic outward force 608a may be about 25 N. The first selected range of chronic outward force 606a may be about ON. In other words, the first selected range of chronic outward force 606a may not be a range at all but rather may be approximately the same as the first nominal chronic outward force 608a.

The second selected indication range 602b may extend from about 5.0 mm to about 6.0 mm or, in other words, the second selected indication range 602b may be about 1.0 mm. The second selected nominal chronic outward force 608b may be about 15 N. The second selected range of chronic outward force 606b may extend from a lower limit of about 10 N to an upper limit of about 20 N, or, in other words, the second selected range of chronic outward force 606b may be about 10 N.

The selected range of chronic outward force 606b may include an upper range 607a and a lower range 607b. The upper range 507a may be about 5 N and the lower range 607b may be about 5 N.

The second indication range 602b, in the present embodiment, is shown extending to the nominal diameter 604b of the endoprosthesis. In practice, an indication range would terminate prior to the nominal diameter of the endoprosthesis in order to provide at least some radial force near the end of the indication range. However, an endoprosthesis may be designed that pushes the upper limits of the nominal diameter.

The chronic outward force over diameter curve 690 may have a slope. As shown in the graph 600, the slope of the chronic outward force over diameter curve 690 in the first and second indication range 602a, 602b is approximately zero. Other chronic outward force over diameter curves may satisfy the first indication range 602a, first nominal diameter 604a, and the first range of chronic outward force 606a requirements and/or may satisfy the second indication range 602b, second nominal diameter 604b, and the second range of chronic outward force 606b requirements shown in FIG. 7.

For example, an endoprosthesis designed to satisfy the first requirements may have a chronic outward force over diameter curve with a zero slope that extends from about 25 N at 2.5 mm to about 25 N at 4.0 mm, but which may vary outside of the selected first indication range 602a and selected first range of chronic outward force 606a. In another example, an endoprosthesis designed to satisfy the second requirements may have a chronic outward force over diameter curve with a −5.0 N/mm slope that extends from about 20 N at 5.0 mm to about 10 N at 6.0 mm, but which may vary outside of the selected first indication range 602a and selected first range of chronic outward force 606b. In addition, these curves need not be linear, but rather must simply fall within the window of the indication range 602b and the range of chronic outward force 606b.

Any other chronic outward force over diameter curve 690 for an endoprosthesis that falls within the first and second indication ranges 602a, 602b and the first and second ranges of chronic outward force 606a, 606b may satisfy the act 106 of determining at least one design characteristic. Although, other design criteria may be considered.

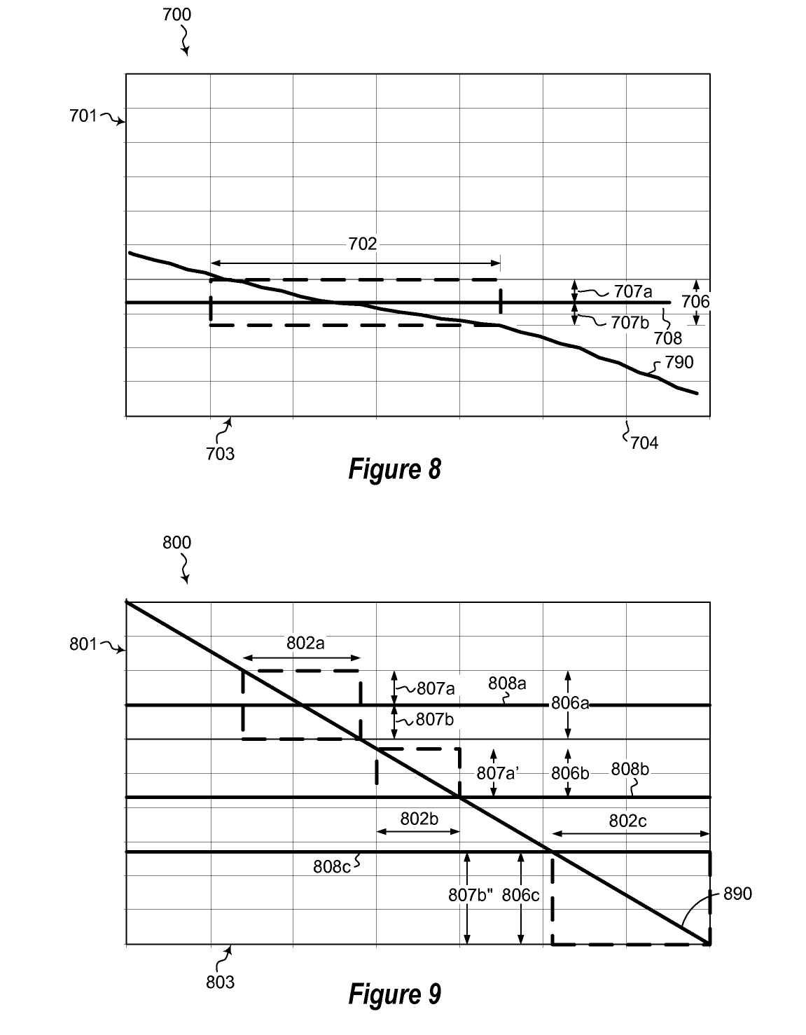

FIG. 8 illustrates a graph 700 of a curve 790 of a range of radial forces 701 over a range of body lumen or vessel diameters 703 of an embodiment of an endoprosthesis having a range of radial force 706 that includes an upper and lower range 707a, 707b of radial force that have the same values. Although the method 100 described in connection with the description of FIG. 2 includes the act 106 of selecting a range of chronic outward force, the principles described in the method 100 may be applied with respect to curves 790 based on radial forces 701 rather than chronic outward forces (shown as 301 in FIG. 4).

Although referring to radial forces 701 rather than chronic outward forces, the graph 700 of this other embodiment may be similar to the graphs 300, 400, 500, 600 previously described above and shown in FIGS. 4-7 in most respects, wherein certain aspects will not be described in relation to this embodiment wherein those aspects may be similar to the aspects as described above and are hereby incorporated into this alternative embodiment described below. Like elements may be given like reference numerals.

The range of radial forces 701 may extend from the about ON to about 100 N and the range of diameters 703 may extend from about 5.0 mm to about 8.5 mm. The present embodiment of an endoprosthesis may have a nominal diameter 704 of about 8 mm. In other embodiments, the endoprosthesis may have another nominal diameter 704.

In the present embodiment, the radial force over diameter curve 790 may be generated by an endoprosthesis with at least one design characteristic determined based on an indication range 702, a range of radial forces 706, and the nominal radial force 708. The selected indication range 702 may extend from about 5.5 mm to about 7.25 mm or, in other words, the selected indication range 702 may be about 1.75 mm. The selected nominal radial force 708 may be about 33 N.

The selected range of radial force 706 may extend from a lower limit of about 26 N to an upper limit of about 40 N, or, in other words, the selected range of radial force 706 may be about 14 N.

The selected range of radial force 706 may include an upper range 707a and/or a lower range 707b. The upper range 707a and the lower range 707b may be approximately the same. In the present embodiment, the upper range 707a and the lower range 707b may be about 7 N. In other embodiments, the upper range 707a and the lower range 707b may be different. In further embodiments, the range of radial force 706 may only include the upper range 707a or the lower range 707b.

The radial force over diameter curve 790 may have a slope. As shown in the graph 700, the slope of the radial force over diameter curve 790 is not constant and is relatively small. Other radial force over diameter curves may satisfy the indication range, nominal diameter, and the range of radial force requirements shown in FIG. 8. For example, an endoprosthesis designed to satisfy these requirements may have a radial force over diameter curve with a constant slope of −8.0 N/mm that extends from 40 N at 5.5 mm to 26 N at 7.25 mm, but which may vary outside of the selected indication range 702 and selected range of radial force 706.

Any other radial force over diameter curve 790 for an endoprosthesis that falls within the indication range 702 and the range of radial force 706 may satisfy the act 106 of determining at least one design characteristic. Although, other design criteria than the indication range 702 and the range of radial force 706 may be considered, such as the nominal diameter 704, nominal radial force 708, other design criteria or characteristics, or combinations thereof.

FIG. 9 illustrates a graph 800 of a curve 890 of a range of radial forces 801 over a range of body lumen or vessel diameters 803 of an embodiment of an endoprosthesis having a first, second, and third nominal radial forces 808a, 808b, 808c over a first, second, and third indication range 802a, 802b, 802c, respectively. Although the method 100 described in connection with the description of FIG. 2 includes the act 106 of selecting a range of chronic outward force, the principles described in the method 100 may be applied with respect to curves 890 (and 790 shown in FIG. 8) based on radial forces 801 rather than chronic outward forces (shown as 301 in FIG. 4).

The graph 800 of this other embodiment may be similar to the graph 700 previously described above and shown in FIG. 9 in most respects, wherein certain aspects will not be described in relation to this embodiment wherein those aspects may be similar to the aspects as described above and are hereby incorporated into this alternative embodiment described below. Although referring to radial forces 801 rather than chronic outward forces, the graph 800 of this other embodiment may be similar to the graphs 300, 400, 500, 600 previously described above and shown in FIGS. 4-7 in most respects, wherein certain aspects will not be described in relation to this embodiment wherein those aspects may be similar to the aspects as described above and are hereby incorporated into this alternative embodiment described below. Like elements may be given like reference numerals.

The range of radial forces 801 may extend from the about 0 N to about 100 N and the range of diameters 803 may extend from about 5.0 mm to about 8.5 mm. The present embodiment of an endoprosthesis may have a nominal diameter 804 of about 8 mm. In other embodiments, the endoprosthesis may have another nominal diameter 804.

In the present embodiment, the radial force over diameter curve 890 may be generated by an endoprosthesis with at least one design characteristic determined based on a first, second, and third indication range 802a, 802b, 802c, a first, second, and third range of radial forces 806a, 806b, 806c, and the first, second, and third nominal radial force 808a, 808b, 808c. The first selected indication range 802a may extend from about 5.75 mm to about 6.45 mm or, in other words, the first selected indication range 802a may be about 0.7 mm. The first selected nominal radial force 808a may be about 70 N. The first selected range of radial force 806a may extend from a lower limit of about 60 N to an upper limit of about 80 N, or, in other words, the selected range of radial force 806 may be about 20 N.

The selected range of radial force 806 may include an upper range 807a and/or a lower range 807b. The upper range 807a and the lower range 807b may be approximately the same. In the present embodiment, the upper range 807a and the lower range 807b may be about 10N. In other embodiments, the upper range 807a and the lower range 807b may be different. In further embodiments, the range of radial force 806 may only include the upper range 807a or the lower range 807b.

The second selected indication range 802b may extend from about 6.5 mm to about 7.0 mm or, in other words, the second selected indication range 802b may be about 0.5 mm. The second selected nominal radial force 808b may be about 43.6 N. The second selected range of radial force 806b may extend from a lower limit of about 43.6 N to an upper limit of about 57.9 N, or, in other words, the selected range of radial force 806 may be about 14.3 N.

The second selected range of radial force 806b may include an upper range 807a′ and/or a lower range. The upper range 807a′ may be about 14.3 N and the lower range may be about ON. In other words, the second selected range of radial force 806b may not include a lower range.

The third selected indication range 802c may extend from about 7.52 mm to about 8.5 mm or, in other words, the third selected indication range 802c may be about 0.98 mm. The third selected nominal radial force 808c may be about 28 N. The third selected range of radial force 806c may extend from a lower limit of about 0 N to an upper limit of about 28 N, or, in other words, the selected range of radial force 806 may be about 28 N.

The third selected range of radial force 806c may include an upper range and/or a lower range 807b″. The lower range 807b″ may be about 28 N and the upper range may be about ON. In other words, the third selected range of radial force 806c may not include an upper range.

The radial force over diameter curve 890 may have a slope. As shown in the graph 800, the slope of the radial force over diameter curve 890 is constant and is about −28.57 N/mm. Other radial force over diameter curves may satisfy the first indication range 802a, first nominal diameter 804a, and the first range of radial force 806a requirements; the second indication range 802b, second nominal diameter 804b, and the second range of radial force 806b requirements; the third indication range 802c, third nominal diameter 804c, and the third range of radial force 806c requirements; or combinations thereof.

Any other radial force over diameter curve 890 for an endoprosthesis that falls within the indication ranges 802a, 802b, 802c and the ranges of radial force 806a, 806b, 806c may satisfy the act 106 of determining at least one design characteristic. Although, other design criteria than the indication ranges 802a, 802b, 802c and the ranges of radial force 806a, 806b, 806c may be considered, such as the nominal diameter 804a, 804b, 804c, nominal radial forces 808a, 808b, 808c, other design criteria or characteristics, or combinations thereof.

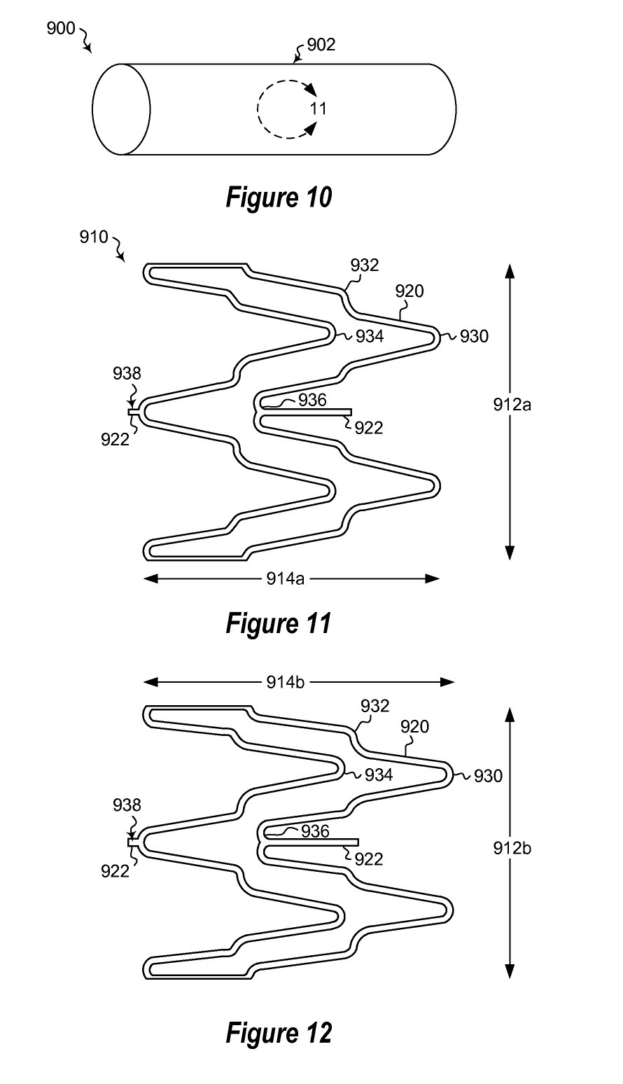

FIG. 10 is an illustration of an embodiment of a stent 900. The stent 900 may be designed according to the methods 100, 200 previously described above and shown in FIGS. 2-3 or other methods described herein. The stent 900 may include a wall 902 that may be manufactured based on the methods described herein.

The endoprostheses, such as stent 900, of the present disclosure can be made of a variety of materials, such as, but not limited to, materials known in the art of endoprosthesis manufacturing. Generally, the materials for the stent can be selected according to the structural performance and biological characteristics that are desired.

The struts 920, 922 and/or crowns 930, 932, 934, 936, 938 can include resiliently flexible materials or rigid and inflexible materials. For example, materials such as Ti3A12.5V, Ti6A14V, and platinum may be particularly good choices for adhering to a flexible material, such as, but not limited to, Nitinol and providing good crack arresting properties. The use of resiliently flexible materials can provide shock-absorbing characteristics to the large end portions and/or the tapered central portions, which can also be beneficial for absorbing stress and strains, which may inhibit crack formation at high stress zones. For example, types of materials that are used to make an endoprosthesis can be selected so that the endoprosthesis is capable of being collapsed during placement and expanded when deployed. Usually, the endoprosthesis can be self-expanding, balloon-expandable, or can use some other configuration for deployment.

In one embodiment, a stent of the present invention can include a material made from any of a variety of known suitable materials, such as a shape memory material (SMM). For example, the SMM can be shaped in a manner that allows for restriction to induce a substantially tubular, linear orientation while within a delivery shaft, but can automatically retain the memory shape of the stent once extended from the delivery shaft. SMMs have a shape memory effect in which they can be made to remember a particular shape. Once a shape has been remembered, the SMM may be bent out of shape or deformed and then returned to its original shape by unloading from strain or heating. Typically, SMMs can be shape memory alloys (SMA) including metal alloys, or shape memory plastics (SMP) including polymers.

The main types of SMAs are as follows: copper-zinc-aluminium; copper-aluminium-nickel; nickel-titanium (NiTi) alloys known as nitinol; and cobalt-chromium-nickel alloys or cobalt-chromium-nickel-molybdenum alloys known as elgiloy alloys.

A Shape Memory Plastic (SMP) can be fashioned into a stent in accordance with the present invention. When an SMP encounters a temperature above the lowest melting point of the individual polymers, the blend makes a transition to a rubbery state. The elastic modulus can change more than two orders of magnitude across the transition temperature (Ttr). As such, an SMP can formed into a desired shape of a stent, crown, and/or strut element by heating it above the Ttr, fixing the SMP into the new shape, and cooling the material below Ttr. The SMP can then be arranged into a temporary shape by force, and then resume the memory shape once the force has been applied. Examples of SMPs include, but are not limited to, biodegradable polymers, such as oligo(ε-caprolactone)diol, oligo(ρ-dioxanone)diol, and non-biodegradable polymers such as, polynorborene, polyisoprene, styrene butadiene, polyurethane-based materials, vinyl acetate-polyester-based compounds, and others yet to be determined. As such, any SMP can be used in accordance with the present disclosure.

In one embodiment, the stent, crown, and/or strut element can include a variety of suitable deformable alloy metal materials, including stainless steel, silver, platinum, tantalum, palladium, cobalt-chromium alloys or other known biocompatible alloy metal materials.

In one embodiment, the stent can include a suitable biocompatible polymer in addition to or in place of a suitable metal. The polymeric stent can include biodegradable or bioabsorbable materials, which can be either plastically deformable or capable of being set in the deployed configuration. If plastically deformable, the material can be selected to allow the stent to be expanded in a similar manner using an expandable member so as to have sufficient radial strength and scaffolding and also to minimize recoil once expanded. If the polymer is to be set in the deployment configuration, the expandable member can be provided with a heat source or infusion ports to provide the required catalyst to set or cure the polymer. Alternative delivery devices and/or techniques for self-expanding endoprostheses likewise can be used.

Examples of such biocompatible materials for the stent can include a suitable hydrogel, hydrophilic polymer, biodegradable polymers, bioabsorbable polymers and bioneutral polymers. Examples of such polymers can include poly(alpha-hydroxy esters), polylactic acids, polylactides, poly-L-lactide, poly-DL-lactide, poly-L-lactide-co-DL-lactide, polyglycolic acids, polyglycolide, polylactic-co-glycolic acids, polyglycolide-co-lactide, polyglycolide-co-DL-lactide, polyglycolide-co-L-lactide, polyanhydrides, polyanhydride-co-imides, polyesters, polyorthoesters, polycaprolactones, polyesters, polyanydrides, polyphosphazenes, polyester amides, polyester urethanes, polycarbonates, polytrimethylene carbonates, polyglycolide-co-trimethylene carbonates, poly(PBA-carbonates), polyfumarates, polypropylene fumarate, poly(p-dioxanone), polyhydroxyalkanoates, polyamino acids, poly-L-tyrosines, poly(beta-hydroxybutyrate), polyhydroxybutyrate-hydroxyvaleric acids, combinations thereof, or the like.

Furthermore, the stent can be formed from a ceramic material. In one aspect, the ceramic can be a biocompatible ceramic which optionally can be porous. Examples of suitable ceramic materials include hydroxylapatite, mullite, crystalline oxides, non-crystalline oxides, carbides, nitrides, silicides, borides, phosphides, sulfides, tellurides, selenides, aluminum oxide, silicon oxide, titanium oxide, zirconium oxide, alumina-zirconia, silicon carbide, titanium carbide, titanium boride, aluminum nitride, silicon nitride, ferrites, iron sulfide, and the like. Optionally, the ceramic can be provided as sinterable particles that are sintered into the shape of a stent, crown, and/or stent element.

Moreover, the stent can include a radiopaque material to increase visibility during placement. Optionally, the radiopaque material can be a layer or coating any portion of the stent. The radiopaque materials can be platinum, tungsten, silver, stainless steel, gold, tantalum, bismuth, barium sulfate, or a similar material.

It is further contemplated that the external surface and/or internal surface of the stent, crown, and/or strut element (e.g., exterior and/or luminal surfaces) can be coated with another material having a composition different from a primary stent material. The use of a different material to coat the surfaces can be beneficial for imparting additional properties to the stent, such as providing radiopaque characteristics, drug-reservoirs, and improved biocompatibility.

In one configuration, the external and/or internal surfaces of a stent can be coated with a biocompatible polymeric material as described herein. Such coatings can include hydrogels, hydrophilic and/or hydrophobic compounds, and polypeptides, proteins or amino acids or the like. Specific examples can include polyethylene glycols, polyvinylpyrrolidone (PVP), polyvinylalcohol (PVA), parylene, heparin, phosphorylcholine, polytetrafluorethylene (PTFE), or the like.

The coatings can also be provided on the stent to facilitate the loading or delivery of beneficial agents or drugs, such as therapeutic agents, pharmaceuticals and radiation therapies. As such, the endoprosthetic material and/or holes can be filled and/or coated with a biodegradable material.

Accordingly, the coating material can contain a drug or beneficial agent to improve the use of the stent. Such drugs or beneficial agents can include antithrombotics, anticoagulants, antiplatelet agents, thrombolytics, antiproliferatives, anti-inflammatories, agents that inhibit hyperplasia, inhibitors of smooth muscle proliferation, antibiotics, growth factor inhibitors, or cell adhesion inhibitors, as well as antineoplastics, antimitotics, antifibrins, antioxidants, agents that promote endothelial cell recovery, antiallergic substances, radiopaque agents, viral vectors having beneficial genes, genes, siRNA, antisense compounds, oligionucleotides, cell permeation enhancers, and combinations thereof.

In one configuration, different external surfaces of a stent, such as a low stress zone less susceptible to flexing, can be coated with functional layers of an imaging compound or radiopaque material. The radiopaque material can be applied as a layer at low stress zones of the stent. Also, the radiopaque material can be encapsulated within a biocompatible or biodegradable polymer and used as a coating. For example, the suitable radiopaque material can be palladium platinum, tungsten, silver, stainless steel, gold, tantalum, bismuth, barium sulfate, or a similar material. The radiopaque material can be applied as layers on selected surfaces of the stent using any of a variety of well-known techniques, including cladding, bonding, adhesion, fusion, deposition or the like.

Referring generally to FIGS. 11-12, FIG. 11 is an illustration of a web pattern 910 of the stent 900 of FIG. 10 in an uncompressed state and FIG. 12 is an illustration of the web pattern 910 of FIG. 11 in a compressed state. As discussed above, a web pattern may be determined based on an indication range and a range of chronic outer (or radial) force. The web pattern 910 may be formed using a plurality of struts 920, 922 and at least one crown 930, 932, 934, 936. The struts 920, 922 may be interconnected by the crowns 930, 932, 934, 936.

The struts 920 may extend between crowns 930, 932, 934, 936, while connecting struts 922 may connect other web patterns 910 or other stent structures together. The crowns 930, 932, 934 may simply connect struts 920 together. The crowns 936, 938 may connect to connecting struts 922.

The crowns 930, 934, 936, 938 may form an angle of less than one hundred and eighty degrees. Crown 932 may form an angle of more than one hundred and eighty degrees. Other angles, orientations, other aspects, or combinations thereof are also considered.

The web pattern 910 may have a diameter 912a and a length 914a in the uncompressed state and a diameter 912b and a length 914b in the compressed state. As also discussed above, the strut shape, dimensioning, or other strut characteristics as well as the crown shape, dimensioning, or other crown characteristics may be determined. For example, the length of a strut 920, 922 may affect the ability of the stent 900 (or endoprosthesis) to have a flatter (i.e. smaller sloped) chronic outward force over diameter curve and thereby fall within more indication ranges. In other words, a longer strut 920, 922 may facilitate a flatter chronic outward force over diameter curve.

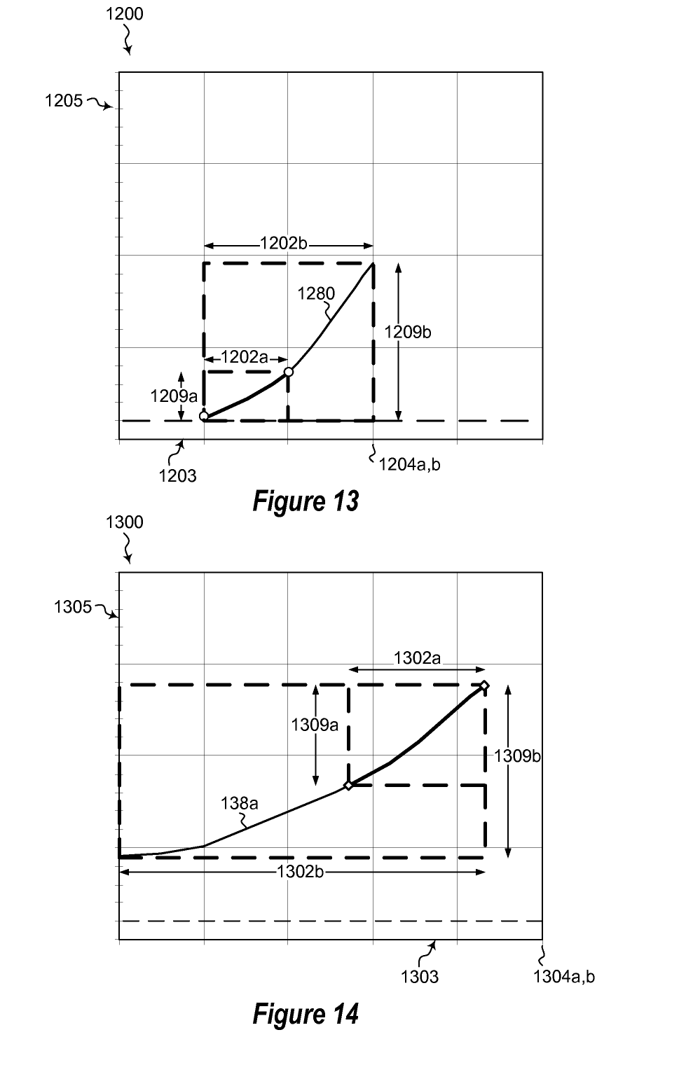

FIG. 13 illustrates a graph 1200 of a curve 1280 of a range of safety factors 1205 over a range of diameters 1203 of an embodiment of an endoprosthesis. The range of safety factors 1205 may extend from 0 to about 20 and the range of diameters 1203 may extend from about 3.0 mm to about 8.0 mm. The present embodiment of an endoprosthesis may have a nominal diameter 1204 of about 6 mm. In other embodiments, the endoprosthesis may have another nominal diameter 1204.

The safety factor over diameter curve 1280 may be specific to the nominal diameter 1204, the design characteristics described herein, other design characteristics, or combinations thereof. The safety factor over diameter curve 1280, as described above, may be determined after an endoprosthesis is designed. For example, the methods of 100, 200 for manufacturing an endoprosthesis described above may produce an endoprosthesis that may be tested to generate such curve 1280.

In the present embodiment, the safety factor over diameter curve 1280 may be generated by an endoprosthesis with at least one design characteristic determined based on first and second indication ranges 1202a, 1202b and first and second ranges of safety factors 1209a, 1209b. Other factors, such as a nominal chronic outward (or radial) force may be used.

The first selected indication range 1202a may extend from about 4.0 mm to about 5.0 mm or, in other words, the selected indication range 1202a may be about 1.0 mm. The first selected range of safety factors 1209a may extend from a lower limit of about 1 to an upper limit of about 4, or, in other words, the first selected range of safety factors 1209a may be about 3.

The second selected indication range 1202b may extend from about 4.0 mm to about 6.0 mm or, in other words, the selected indication range 1202b may be about 2.0 mm. The second selected range of safety factors 1209b may extend from a lower limit of about 1 to an upper limit of about 9, or, in other words, the second selected range of safety factors 1209b may be about 8.

Although the method 200 described above includes the act 206 of selecting a range of safety factors, it will be appreciated that components of the range of safety factors, such as the lower limit, the upper limit, an upper range, a lower range, other components of the range of safety factors, or combinations thereof may be selected.

The safety factor over diameter curve 1280 may have a slope. As shown in the graph 1200, the slope of the safety factor over diameter curve 1280 is not constant and is generally increasing over the diameter. Other safety factor over diameter curves may satisfy the indication range, nominal diameter, and the range of safety factor requirements shown in FIG. 13.

For example, an endoprosthesis designed to satisfy the first requirements may have a safety factor over diameter curve with a constant slope of 3 factors of safety/mm that extends from a safety factor of about 1 at about 4.0 mm to a safety factor of about 4 at about 5.0 mm, but which may vary outside of the selected indication range 1202a and selected range of safety factors 1209a. In another example, an endoprosthesis designed to satisfy the second requirements may have a safety factor over diameter curve with a constant slope of 4 factors of safety/mm that extends from a safety factor of about 1 at about 4.0 mm to a safety factor of about 9 at about 6.0 mm, but which may vary outside of the selected indication range 1202b and selected range of safety factors 1209b.

Any other safety factor over diameter curve 1280 for an endoprosthesis that falls within the first or second indication ranges 1202a, 1202b and the ranges of safety factors 1209a, 1209b may satisfy the act 206 of determining at least one design characteristic. Although, other design criteria than the indication ranges 1202a, 1202b and the range of safety factors 1209a, 1209b may be considered, such as the nominal diameter 1204, a nominal safety factor, other design criteria or characteristics, or combinations thereof. A nominal safety factor would be at least 1.

FIG. 14 illustrates a graph 1300 of a curve 1380 of a range of safety factors 1305 over a range of diameters 1303 of an embodiment of an endoprosthesis. The graph 1300 of this other embodiment may be similar to the graph 1200 previously described above and shown in FIG. 13 in most respects, wherein certain aspects will not be described in relation to this embodiment wherein those aspects may be similar to the aspects as described above and are hereby incorporated into this alternative embodiment described below. Like elements may be given like reference numerals.

The present embodiment of an endoprosthesis may have a nominal diameter 1304 of about 8 mm. In other embodiments, the endoprosthesis may have another nominal diameter 1304. The safety factor over diameter curve 1380 may be generated by an endoprosthesis with at least one design characteristic determined based on first and second indication ranges 1302a, 1302b and first and second ranges of safety factors 1309a, 1309b. Other factors, such as a nominal chronic outward (or radial) force may be used.

The first selected indication range 1302a may extend from about 5.5 mm to about 7.5 mm or, in other words, the selected indication range 1302a may be about 2.0 mm. The first selected range of safety factors 1309a may extend from a lower limit of about 8.5 to an upper limit of about 13.5, or, in other words, the first selected range of safety factors 1309a may be about 5.

The second selected indication range 1302b may extend from about 3.0 mm to about 7.5 mm or, in other words, the selected indication range 1302b may be about 4.5 mm. The second selected range of safety factors 1309b may extend from a lower limit of about 4.5 to an upper limit of about 13.5, or, in other words, the second selected range of safety factors 1309b may be about 9.

The safety factor over diameter curve 1380 may have a slope. As shown in the graph 1300, the slope of the safety factor over diameter curve 1380 is not constant and is generally increasing over the diameter. Other safety factor over diameter curves may satisfy the indication range, nominal diameter, and the range of safety factor requirements shown in FIG. 14.

For example, an endoprosthesis designed to satisfy the first requirements may have a safety factor over diameter curve with a constant slope of 2.5 factors of safety/mm that extends from a safety factor of about 8.5 at about 5.5 mm to a safety factor of about 13.5 at about 7.5 mm, but which may vary outside of the selected indication range 1302a and selected range of safety factors 1309a. In another example, an endoprosthesis designed to satisfy the second requirements may have a safety factor over diameter curve with a constant slope of 2 factors of safety/mm that extends from a safety factor of about 4.5 at about 3.0 mm to a safety factor of about 13.5 at about 7.5 mm, but which may vary outside of the selected indication range 1302b and selected range of safety factors 1309b.

Any other safety factor over diameter curve 1380 for an endoprosthesis that falls within the first or second indication ranges 1302a, 1302b and the ranges of safety factors 1309a, 1309b may satisfy the act 206 of determining at least one design characteristic. Although, other design criteria than the indication ranges 1302a, 1302b and the range of safety factors 1309a, 1309b may be considered, such as the nominal diameter 1304, a nominal safety factor, other design criteria or characteristics, or combinations thereof.

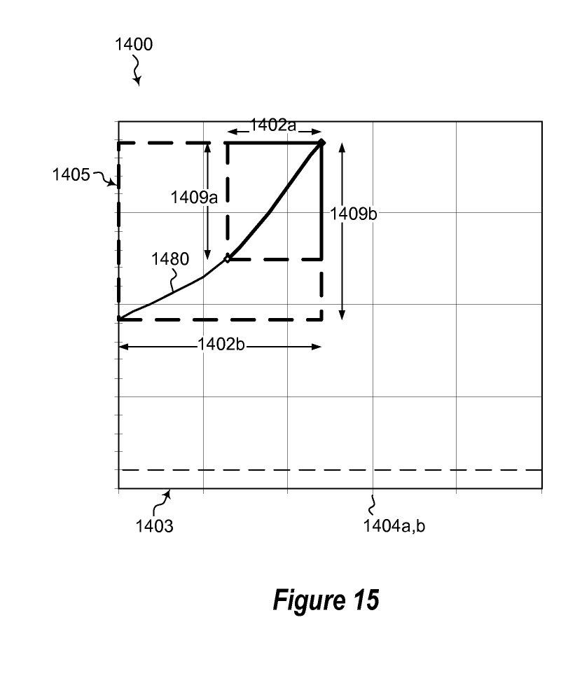

FIG. 15 illustrates a graph 1400 of a curve 1480 of a range of safety factors 1405 over a range of diameters 1403 of an embodiment of an endoprosthesis. The graph 1400 of this other embodiment may be similar to the graphs 1200, 1300 previously described above and shown in FIGS. 13-14 in most respects, wherein certain aspects will not be described in relation to this embodiment wherein those aspects may be similar to the aspects as described above and are hereby incorporated into this alternative embodiment described below. Like elements may be given like reference numerals.

The present embodiment of an endoprosthesis may have a nominal diameter 1404 of about 6 mm. The safety factor over diameter curve 1480 may be generated by an endoprosthesis with at least one design characteristic determined based on first and second indication ranges 1402a, 1402b and first and second ranges of safety factors 1409a, 1409b. Other factors, such as a nominal chronic outward (or radial) force may be used.

The first selected indication range 1402a may extend from about 4.25 mm to about 5.5 mm or, in other words, the selected indication range 1402a may be about 1.25 mm. The first selected range of safety factors 1409a may extend from a lower limit of about 12.5 to an upper limit of about 18.5, or, in other words, the first selected range of safety factors 1409a may be about 6.

The second selected indication range 1402b may extend from about 3.0 mm to about 5.5 mm or, in other words, the selected indication range 1402b may be about 2.5 mm. The second selected range of safety factors 1409b may extend from a lower limit of about 9.0 to an upper limit of about 18.5, or, in other words, the second selected range of safety factors 1409b may be about 9.5.

The safety factor over diameter curve 1480 may have a slope. As shown in the graph 1400, the slope of the safety factor over diameter curve 1480 is not constant and is generally increasing over the diameter. Other safety factor over diameter curves may satisfy the indication range, nominal diameter, and the range of safety factor requirements shown in FIG. 15.

For example, an endoprosthesis designed to satisfy the first requirements may have a safety factor over diameter curve with a constant slope of 4.8 factors of safety/mm that extends from a safety factor of about 12.5 at about 4.25 mm to a safety factor of about 18.5 at about 5.5 mm, but which may vary outside of the selected indication range 1402a and selected range of safety factors 1409a. In another example, an endoprosthesis designed to satisfy the second requirements may have a safety factor over diameter curve with a constant slope of 3.8 factors of safety/mm that extends from a safety factor of about 9.0 at about 3.0 mm to a safety factor of about 18.5 at about 5.5 mm, but which may vary outside of the selected indication range 1402b and selected range of safety factors 1409b.

Any other safety factor over diameter curve 1480 for an endoprosthesis that falls within the first or second indication ranges 1402a, 1402b and the ranges of safety factors 1409a, 1409b may satisfy the act 206 of determining at least one design characteristic. Although, other design criteria than the indication ranges 1402a, 1402b and the range of safety factors 1409a, 1409b may be considered, such as the nominal diameter 1404, a nominal safety factor, other design criteria or characteristics, or combinations thereof.

The present disclosure may be embodied in other specific forms without departing from its spirit or essential characteristics. For example, slight modifications are contemplated and possible and still be within the spirit of the present disclosure and the scope of the claims. The scope of the invention is, therefore, indicated by the appended claims rather than by the foregoing description.

What is claimed is:

1. A method for manufacturing an endoprosthesis:
selecting an indication range based on a range of inner diameters of a body lumen;
selecting a nominal diameter of the endoprosthesis;
selecting a range of chronic outward force; and
determining a design characteristic based on the indication range, the nominal diameter, and the range of chronic outward force.

2. The method of claim 1, further comprising selecting a nominal chronic outward force.

3. The method of claim 2, wherein the nominal chronic outward force is at least sufficient to maintain vessel patency.

4. The method of claim 1, wherein the range of chronic outward force is between about ON to about 10 N.

5. The method of claim 4, wherein the range of chronic outward force is between about 1 N to about 8 N.

6. The method of claim 5, wherein the range of chronic outward force is between about 3 N to about 6 N.

7. The method of claim 1, wherein the indication range is between about 1 mm to about 5 mm of inner diameters of the vessel.

8. The method of claim 1, wherein the indication range is based on a length of a treatment site.

9. The method of claim 1, wherein the design characteristic is at least one of material type, material processing, web pattern, wall coverage, vessel compliance, and fatigue life.

10. The method of claim 9, wherein the design characteristic is the web pattern and the web pattern comprises a plurality of struts and a plurality of crowns connecting the plurality of struts.

11. The method of claim 10, wherein an aspect of the plurality of struts is determined based on the indication range and the range of chronic outward force.

12. The method of claim 1, wherein the nominal diameter is between about 4 mm and about 12 mm.

13. A method for manufacturing an endoprosthesis:
selecting an indication range based on a range of inner diameters of a body lumen;
selecting a nominal diameter of the endoprosthesis;
selecting a range of safety factors; and
determining a design characteristic based on the indication range, the nominal diameter, and the range of safety factors.

14. The method of claim 13, wherein the indication range is between about 1 mm to about 5 mm of inner diameters of the vessel and the range of safety factors extends from at least about 1.

15. The method of claim 13, wherein the safety factors are based on an endoprosthesis design that does not fracture for about four million pulse cycles at about three percent vessel dilation.

16. The method of claim 15, wherein the nominal diameter of the endoprosthesis is about 6 mm and the indication range extends from about 2 mm of inner diameters of the vessel and the range of safety factors extends from at least about 1 to about 10.

17. The method of claim 15, wherein the nominal diameter of the endoprosthesis is about 8 mm and the indication range extends from about 4.5 mm of inner diameters of the vessel and the range of safety factors extends from at least about 4 to about 14.

18. The method of claim 15, wherein the nominal diameter of the endoprosthesis is about 6 mm and the indication range extends from about 2.5 mm of inner diameters of the vessel and the range of safety factors extends from at least about 9 to about 19.

19. The method of claim 13, wherein the design characteristic is at least one of material type, material processing, web pattern, wall coverage, vessel compliance, and fatigue life.

20. The method of claim 19, wherein the design characteristic is the web pattern and the web pattern comprises a plurality of struts and a plurality of crowns connecting the plurality of struts.

21. The method of claim 20, wherein a length of the plurality of struts is determined based on the indication range and the range of safety factors.

22. A method for manufacturing a self-expanding stent, comprising:
selecting an indication range based on a range of inner vessel diameters, the indication range being between about 3.0 mm to about 5.5 mm;
selecting a range of chronic outward force extending between about 3 N to about 6 N;
determining a design characteristic based on a nominal diameter of about 6.0 mm, the indication range, and the range of chronic outward force; and
manufacturing the self-expanding stent based on the determined design characteristic.

23. The method of claim 22, wherein a nominal chronic outward force is about 15 N.

24. The method of claim 23, wherein the range of chronic outward force extends from about 9 N to about 18 N.
